(19) United States
(12) Patent Application Publication
(10) Pub. No.: US 2017/0272685 A1
(43) Pub. Date: Sep. 21, 2017

(54) METHOD FOR VIDEO PLAYING AND ELECTRONIC DEVICE

(71) Applicants: Le Holdings (Beijing) Co., Ltd., Beijing (CN); LE SHI INTERNET INFORMATION & TECHNOLOGY CORP., BEIJING, Beijing (CN)

(72) Inventor: Yaying QIAN, Beijing (CN)

(21) Appl. No.: 15/246,786

(22) Filed: Aug. 25, 2016

Related U.S. Application Data
(63) Continuation of application No. PCT/CN2016/089045, filed on Jul. 7, 2016.

(30) Foreign Application Priority Data
Mar. 21, 2016 (CN) 201610162035.4

(51) Int. Cl. H04N 5/57; H04N 5/445

(52) U.S. Cl. CPC H04N 5/57; H04N 5/44591

(57) ABSTRACT

A method for video playing. The method includes: during play of a video in a non-full-screen play state, starting timing from zero each time an operation instruction is received; and if a timing duration reaches a first predetermined time interval, displaying other regions apart from a video play window as dark regions, and entering a light-off state and continuing playing the video.

### CROSS REFERENCE TO RELATED APPLICATIONS

The present disclosure is a continuation application of PCT International patent application No. PCT/CN2016/089045, filed on Jul. 7, 2016, which claims priority to Chinese Patent Application No. 201610162035.4, filed with the Chinese Patent Office on Mar. 21, 2016, both of which are herein incorporated by reference in their entireties.

### TECHNICAL FIELD

The present disclosure relates to the technical field of data processing, and more particularly, to a method for video playing and electronic device

### BACKGROUND

With the rapid development and drastic popularity of intelligent electronic devices, users using intelligent electronic devices increasingly tend to watch their interested and desired movies, TVs, entertainment programs and the like by using video play software.

When a video is played by using the video play software in the related art, a firstly displayed interface is an interface in a non-full-screen play state. Generally, the video is played in a video play window which occupies ¼ to ½ of a screen and displayed at an upper-left corner, and content such as some necessary information, operation buttons or the like is displayed in other regions on the screen.

### SUMMARY

An embodiment of the present disclosure provides a method for video playing the method includes:

starting timing from zero each time an operation instruction is received, during play of a video in a non-full-screen play state; and

displaying other regions apart from a video play window as dark regions, and entering a light-off state and continuing playing the video, if a timing duration reaches a first predetermined time interval.

Another embodiment of the present disclosure provides an electronic device, the electronic device includes: at least one processor, and a memory. The memory is communicably connected with the at least one processor and for storing instructions executable by the at least one processor. Wherein execution of the instructions by the at least one processor causes the at least one processor to:

start timing from zero each time an operation instruction is received, during play of a video in a non-full-screen play state; and

display other regions apart from a video play window as black regions, and enter a light-off state and continuing playing the video, if a timing duration reaches a first predetermined time interval.

Still another embodiment of the present disclosure provides a non-transitory computer-readable storage medium. The non-transitory computer-readable storage medium stores executable instructions, wherein when the executable instructions are executed by an electronic device, causes the electronic device to:

start timing from zero each time an operation instruction is received, during play of a video in a non-full-screen play state; and

display other regions apart from a video play window as black regions, and enter a light-off state and continuing playing the video, if a timing duration reaches a first predetermined time interval.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow diagram illustrating a method for video playing in accordance with some embodiments;

FIG. 2 is a flow diagram illustrating a method for video playing in accordance with some embodiments;

FIG. 3 is a block diagram illustrating an apparatus for video playing in terms of modules in accordance with some embodiments; and

FIG. 4 is a block diagram illustrating a apparatus for video playing in accordance with some embodiments.

### DETAILED DESCRIPTION

To make the objectives, technical solutions, and advantages of the present disclosure clearer, the present disclosure is described in detail with reference to the accompanying drawings and specific embodiments.

It should be noted that, the terms “first” and “second” used in the embodiments of the present disclosure are two non-identical entities or non-identical parameters having the identical name. It is apparent that the terms “first” and “second” are given herein for illustration convenience, and shall not be construed as limiting the embodiments of the present disclosure. Such terms are not described in the following embodiments any further.

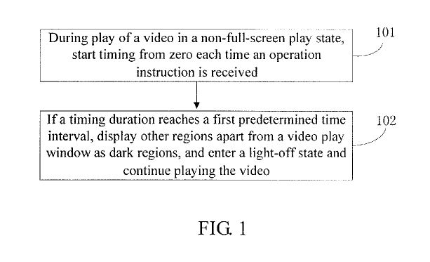

An embodiment of the embodiments of the present disclosure provides a method for video playing which is capable of better eliminating adverse impacts caused by content displayed in other regions apart from the a video play window on a screen to user watching experience. As illustrated in FIG. 1, a schematic flowchart illustrating a method for video playing according to one embodiment of the present disclosure is given.

The method for video playing is applied to a video playing terminal device and includes the following blocks:

block 101: during play of a video in a non-full-screen play state, starting timing from zero each time an operation instruction is received; wherein the non-full-screen play state refers to a state in which the video being currently played is not in a full-screen play mode, and the operation instruction may be any operation instruction, for example, tap on any region on the screen, adjustment of the size of the video play window in the non-full-screen play state, tap on an icon (for example, pause, fast forward and the like) in the video play window, and the like operations; herein, each time any operation instruction is received, timing is restarted from zero; and

block 102: if a timing duration reaches a first predetermined time interval, displaying other regions apart from a video play window as dark regions, and entering a light-off state and continuing playing the video; wherein the first predetermined time interval may be a default value or may be a user-customized value, for example, 30 seconds; and when other regions apart from the video play window are displayed as dark regions, the current play mode is switched to a light-off state, that is, the other regions apart from the video play window are all displayed as dark regions, but the video being currently played is still played, causing no impact to user's watching.

As seen from the above embodiment, in the method for video playing according to the embodiments of the present disclosure, a timing mechanism is configured, and if no operation instruction is received when a timing duration reaches a predetermined time interval, other regions apart from a video play window on a screen are displayed as dark regions and the screen enters a light-off state, such that content in the other regions apart from the video play window is automatically shielded. In this way, adverse impacts caused to user's watching experience of the video are eliminated, and the watching experience is improved.

In some exemplary embodiments, the block of displaying other screen regions apart from a video play window as black regions may further include the following block:

within a second predetermined time interval, gradually deepening a gray scale of the other screen regions apart from the video play window until the other screen regions become dark regions; wherein the second predetermined time interval may be a default value or may be customized by a user, for example, 3 seconds or 5 seconds; and gradually displaying the other screen regions as dark regions, in one aspect prevents adverse impacts caused by abrupt changes of the colors on the screen to user's watching experience, and in another aspect prompting the user that the screen would immediately enters the light-off state.

Further, in some optional embodiments, during the course of gradually displaying the other screen regions as dark regions, a block of displaying a countdown identifier by using a third predetermined time interval as a time length in the other screen regions apart from the video play window may be added; wherein the third predetermined time interval may be a default value, or may be a user-customized value, and the value of the third predetermined time interval is generally the same as the second predetermined time interval, for example, 3 seconds or 5 seconds; and configuring a countdown mechanism enhances the prompt function for the user, and in addition, indication information such as “the screen would immediately enters the light-off state” may also be added in the vicinity of the countdown identifier, to indicate the function of the countdown mechanism.

In some exemplary embodiments, the block of displaying a countdown identifier by using a third predetermined time interval as a time length in the other screen regions apart from the video play window may also be independently configured. That is, this block is not coexistent with the block of deepening a gray scale of the other screen regions apart from the video play window until the other screen regions become dark regions, and instead, the countdown mechanism is independently configured, which likewise achieves the function of prompting the user.

In some exemplary embodiments, prior to the block of entering a light-off state and continuing playing the video, the method may further include the following block:

placing the video play window in the non-full-screen play state at a center of the screen.

According to the above embodiments, in a non-full-screen play state, if no operation instruction from a user is received within a predetermined time period, the video play window is placed at a center of the screen, and the other screen regions are displayed as dark regions. In this way, the user may enter a good watching mode in a light-off state with no need of performing any operation, which is more suitable for watching preferences of the user, and improves user's watching experience.

In some exemplary embodiments, prior to the block of entering a light-off state and continuing playing the video, the method further includes: generating a light-off prompt tone; wherein the light-off prompt tone may be a sound which the same as or similar to the sound of pressing a switch button or pulling a lamp cord for turning off the light, to provide a sound effect of turning off the light for the user. In this way, an immersive sense is created to the user, and user experience is improved.

Further, in some optional embodiments, after the block of entering a light-off state and continuing playing the video, the method may further include the following blocks:

monitoring content in the other screen regions apart from the video play window in the light-off state;

locally lighting a region where updated content is located when it is monitored that content in any of the other screen regions is updated; and

entering the light-off state again if light-on time exceeds a fourth predetermined time interval; wherein the fourth predetermined time interval may be a default value or may be a user-customized value; and the value of the fourth predetermined time interval may be the same as the second predetermined time interval or the third predetermined time interval, for example, 3 seconds or 5 seconds, or may be defined as a different value, for example, 10 seconds.

For example, in the light-off state, if content in any of the other screen regions is updated, with respect to the location where the updated content is located, the blocks centering the updated content is lit, such that the updated content is displayed for the user; if the user performs no operation for the updated content within the fourth predetermined time interval, it indicates that the user is not interested in such content, and the screen enters the light-off state, such that the user may not miss some updated content while watching the video in the light-off state, thereby bettering user experience.

In some exemplary embodiments, after the block of entering a light-off state and continuing playing the video, the method further includes:

receiving an operation instruction in the light-off state;

judging whether the operation instruction is directed to a video which is being played;

if the operation instruction is directed to a video which is being played, maintaining the light-off state, and performing a corresponding operation for the video which is being played according to the operation instruction; and

if the operation instruction is not directed to a video which is being played, returning to the initial non-full screen play state, and performing a corresponding operation according to the operation instruction; wherein, herein the operation instruction not directed to the video which is being played may be issued when any position in the other screen regions which are displayed as dark regions is tapped, and in this case, the corresponding operation is activating icons, text links and the like content in the other screen regions, such that the user is capable of performing a further operation for the same; in addition, the operation instruction not directed to the video which is being played may also be issued when a floating icon displayed at any position in the other screen regions which are displayed as dark regions is tapped, and in this case, the corresponding operation may be an operation triggered with respect to the corresponding icon.

An object to which an operation instruction is directed in the light-off state is differentiated, such that the screen may not return to the non-full-screen play state when a user performs such an operation as pause, fast forward, backward or the like; and instead a watching effect in the light-off state is maintained. However, when an operation instruction is directed to the other regions apart from the video play window in which the video is being played, the screen returns to the initial non-full-screen play state, and a corresponding operation is performed, thereby improving user experience.

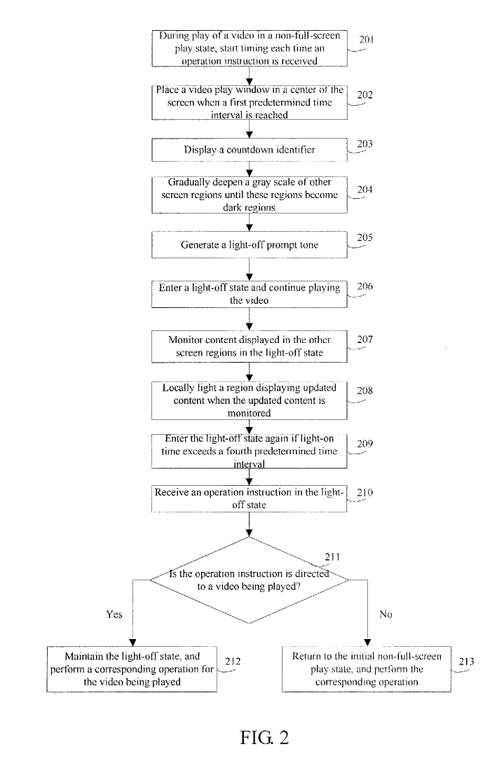

The present disclosure further provides another embodiment illustrating a video playing method. As illustrated in FIG. 2, a schematic flowchart of a method for video playing according to another embodiment of the present disclosure is given.

The method for video playing includes the following blocks:

block 201: during play of a video in a non-full-screen play state, starting timing from zero each time an operation instruction is received; and

Block 202: placing the video play window in the non-full-screen play state at a center of the screen if a timing duration reaches a first predetermined time interval;

block 203: in the other screen regions apart from the video play window, displaying a countdown identifier by using a third predetermined time interval as a time length.

block 204: within a second predetermined time interval, gradually deepening a gray scale of the other screen regions apart from the video play window until the other screen regions become dark regions;

block 205: generating a light-off prompt tone;

block 206: entering a light-off state and continuing playing the video;

block 207: monitoring content in the other screen regions apart from the video play window in the light-off state;

block 208: locally lighting a region where updated content is located when it is monitored that content in any of the other screen regions is updated;

block 209: entering the light-off state again if light-on time exceeds a fourth predetermined time interval;

block 210: receiving an operation instruction in the light-off state;

block 211: judging whether the operation instruction is directed to a video which is being played;

block 212: if the operation instruction is directed to a video which is being played, maintaining the light-off state, and performing a corresponding operation for the video which is being played; and

block 213: if the operation instruction is not directed to a video which is being played, returning to the initial non-full screen play state, and performing a corresponding operation.

As seen from the above embodiment, in the method for video playing according to the present disclosure, a timing mechanism is configured, and if no operation instruction is received when a timing duration reaches a predetermined time interval, other regions apart from a video play window on a screen are displayed as dark regions and the screen enters a light-off state, such that content in the other regions apart from the video play window is automatically shielded. In this way, adverse impacts caused to user's watching experience of the video are eliminated, and the watching experience is improved.

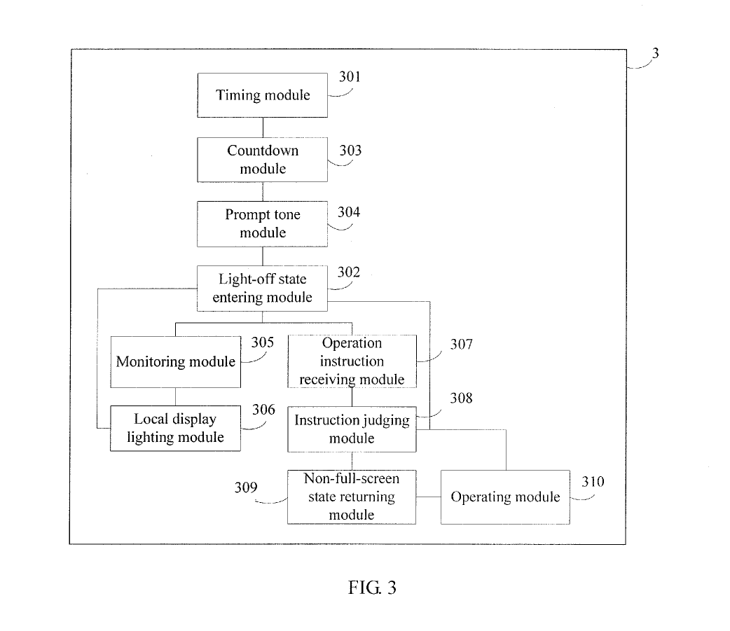

A second embodiment of the embodiments of the present disclosure further provides a method for video playing which is capable of better eliminating adverse impacts caused by content displayed in other regions apart from the a video play window on a screen to user watching experience. As illustrated in FIG. 3, a schematic structural diagram illustrating a apparatus for video playing 3 in terms of modules according to one embodiment of the present disclosure is given.

The apparatus for video playing 3 includes:

A countdown module 301, configured to, during play of a video in a non-full-screen play state, start timing from zero each time an operation instruction is received; wherein the non-full-screen play state refers to a state in which the video being currently played is not in a full-screen play mode, and the operation instruction may be any operation instruction, for example, tap on any region on the screen, adjustment of the size of the video play window in the non-full-screen play state, tap on an icon (for example, pause, fast forward and the like) in the video play window, and the like operations; herein, each time any operation instruction is received, timing is restarted from zero; and

a light-off state entering module 302, configured to, if a timing duration reaches a first predetermined time interval, display other regions apart from a video play window as black regions, and enter a light-off state and continuing playing the video; wherein the first predetermined time interval may be a default value or may be a user-customized value, for example, 30 seconds; when the other screen regions are displayed as dark regions, the current video play mode is switched to the light-off state, that is, the other regions apart from the video play window are all displayed as dark regions, but the video being currently played is still played, causing no impact to user's watching.

As seen from the above embodiment, in the apparatus for video playing 3 according to the present disclosure, a timing mechanism is configured, and if no operation instruction is received when a timing duration reaches a predetermined time interval, other regions apart from a video play window on a screen are displayed as dark regions and the screen enters a light-off state, such that content in the other regions apart from the video play window is automatically shielded. In this way, adverse impacts caused to user's watching experience of the video are eliminated, and the watching experience is improved.

In some exemplary embodiments, the light-off state entering module 302 is specifically configured to, within a second predetermined time interval, gradually deepen a gray scale of the other screen regions apart from the video play window until the other screen regions become dark regions; wherein the second predetermined time interval may be a default value or may be customized by a user, for example, 3 seconds or 5 seconds; and gradually displaying the other screen regions as dark regions, in one aspect prevents adverse impacts caused by abrupt changes of the colors on the screen to user's watching experience, and in another aspect prompting the user that the screen would immediately enters the light-off state.

Further, in some optional embodiments, the apparatus for video playing 3 further includes a countdown module 303, configured to, in the other screen regions apart from the video play window, display a countdown identifier by using a third predetermined time interval as a time length during the course of gradually displaying the other screen regions as dark regions. The third predetermined time interval may be a default value, or may be a user-customized value, and the value of the third predetermined time interval is generally the same as the second predetermined time interval, for example, 3 seconds or 5 seconds; and configuring a countdown mechanism enhances the prompt function for the user, and in addition, indication information such as “the screen would immediately enters the light-off state” may also be added in the vicinity of the countdown identifier, to indicate the function of the countdown mechanism.

In some exemplary embodiments, the block of displaying a countdown identifier by using a third predetermined time interval as a time length in the other screen regions apart from the video play window may also be independently configured. That is, this block is not coexistent with the block of deepening a gray scale of the other screen regions apart from the video play window until the other screen regions become dark regions, and instead, the countdown mechanism is independently configured, which likewise achieves the function of prompting the user.

In some exemplary embodiments, the light-off entering module 302 is further configured to place the video play window in the non-full-screen play state at a center of the screen.

According to the above embodiments, in a non-full-screen play state, if no operation instruction from a user is received within a predetermined time period, the video play window is placed at a center of the screen, and the other screen regions are displayed as dark regions. In this way, the user may enter a good watching mode in a light-off state with no need of performing any operation, which is more suitable for watching preferences of the user, and improves user's watching experience.

In some exemplary embodiments, the apparatus for video playing 3 further includes a prompt tone module 304, configured to generate a light-off prompt tone. The light-off prompt tone may be a sound which the same as or similar to the sound of pressing a switch button or pulling a lamp cord for turning off the light, to provide a sound effect of turning off the light for the user. In this way, an immersive sense is created to the user, and user experience is improved.

Further, in some optional embodiments, the apparatus for video playing 3 further includes:

a monitoring module 305, configured to monitor content in the other screen regions apart from the video play window in the light-off state; and

a local display lighting module 306, configured to locally highlight display of a region where updated content is located when it is monitored that content in any of the other screen regions is updated;

wherein the light-off state entering module 302 is configured to enter the light-off state again if light-on time exceeds a fourth predetermined time interval. The fourth predetermined time interval may be a default value, or may be a user-customized value. The value of the fourth predetermined time interval may be the same as the second predetermined time interval or the third predetermined time interval, for example, 3 seconds or 5 seconds; or may be defined as a different value, for example, 10 seconds.

For example, in the light-off state, if content in any of the other screen regions is updated, with respect to the location where the updated content is located, the blocks centering the updated content is lit, such that the updated content is displayed for the user; if the user performs no operation for the updated content within the fourth predetermined time interval, it indicates that the user is not interested in such content, and the screen enters the light-off state, such that the user may not miss some updated content while watching the video in the light-off state, thereby bettering user experience.

In some exemplary embodiments, the apparatus for video playing 3 further includes:

an operation instruction receiving module 307, configured to receive an operation instruction in the light-off state;

an instruction judging module 308, configured to judge whether the operation instruction is directed to a video which is being played;

a non-full-screen state returning module 309, configured to return to the initial non-full screen play state if the operation instruction is not directed to a video which is being played;

wherein if the operation instruction is directed to a video which is being played, the light-off state entering module 302 is configured to maintain the light-off state; and

an operating module 310, configured to perform an operation corresponding to the operation instruction. Herein the operation instruction not directed to the video which is being played may be issued when any position in the other screen regions which are displayed as dark regions is tapped, and in this case, the corresponding operation is activating icons, text links and the like content in the other screen regions, such that the user is capable of performing a further operation for the same; in addition, the operation instruction not directed to the video which is being played may also be issued when a floating icon displayed at any position in the other screen regions which are displayed as dark regions is tapped, and in this case, the corresponding operation may be an operation triggered with respect to the corresponding icon.

An object to which an operation instruction is directed in the light-off state is differentiated, such that the screen may not return to the non-full-screen play state when a user performs such an operation as pause, fast forward, backward or the like; and instead a watching effect in the light-off state is maintained. However, when an operation instruction is directed to the other regions apart from the video play window ill which the video is being played, the screen returns to the initial non-full-screen play state, and a corresponding operation is performed, thereby improving user experience.

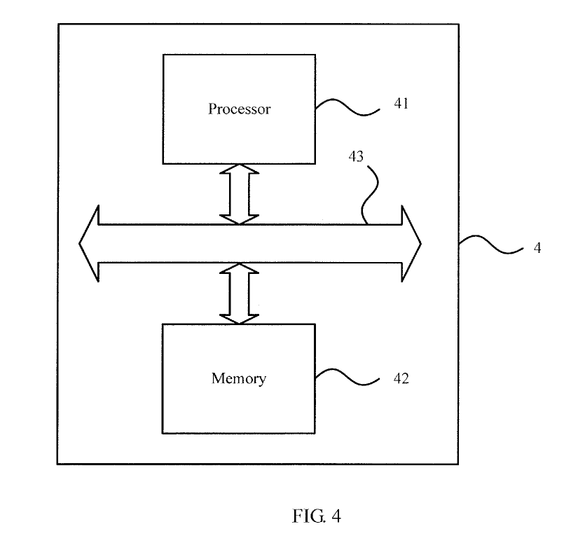

As illustrated in FIG. 4, a schematic structural diagram illustrating a apparatus for video playing 4 according to one embodiment of the present disclosure is given. As illustrated in FIG. 4, the apparatus for video playing 4 includes: a processor 41, a memory 42 and a bus system 43. The processor 41 and the memory 42 are connected to each other via the bus system 43, the memory 42 is configured to store instructions, and the processor 41 is configured to execute the instructions stored in the memory 42 to:

during play of a video in a non-full-screen play state, start timing from zero each time an operation instruction is received; and

if a timing duration reaches a first predetermined time interval, display other regions apart from a video play window as black regions, and enter a light-off state and continuing playing the video.

The memory 42 of the apparatus for video playing 4 may be a non-volatile computer readable storage medium, which is configured to store computer executable instructions. When the instructions are executed by one or a plurality of central processors, for example, a processor may be caused to perform the blocks in the above method embodiments, for example, blocks 101 and 102 illustrated in FIG. 1, blocks 201 to 213 illustrated in FIG. 2, such that the processor implements the functions of the units in the above apparatus embodiments, for example, the functions of units 301 to 310 illustrated in FIG. 3. The computer executable instructions may also be stored and/or transmitted in any non-volatile computer readable storage medium, such that these instructions are used by an instruction executing system, apparatus or device, or used in combination with the instruction executing system, apparatus or device. The instruction executing system, apparatus or device may be, for example, a computer-based system, a system comprising a processor or another system capable of acquiring instructions from the instruction executing system, apparatus or device and executing the instructions. For the purpose of this specification, the “non-volatile computer readable storage medium” may be any tangible medium including or storing computer executable instructions. The computer executable instructions may be used by the instruction executing system, apparatus or device, or used in combination with the executing system, apparatus or device. The non-volatile computer readable storage medium may include, but not limited to, a magnetic, optical and/or semiconductor storage device. Examples of these storage devices include a magnetic disk, an optical disc based on CD, DVD and Blu-ray technology, and permanent solid memory (for example, a flash memory, a solid driver and the like).

It should be understood that in the embodiments of the present application, the processor 41 may be a central processing unit (CPU). The processor 41 may be a general processor, a digital signal processor (DSP), an application specific integrated circuit (ASIC), a field programmable gate array (FPGA) or another programmable logic device, a discrete gate or transistor logic device, or a discrete hardware component. The general processor may be a microprocessor or any customary processor or the like.

In addition to a data bus, the bus system 43 may further include a power bus, a control bus, a state signal bus and the like. However, for clarity of description, various buses are all marked as the bus system 43.

In the embodiments of the present disclosure, the video playing apparatus is not limited to the components and configurations as illustrated in FIG. 4, but may further include other or additional components having a plurality of configurations.

During the implementation, various blocks in the above method and various units in the above apparatus may be implemented by means of an integrated logic circuit in the processor 41 or by means of software. The blocks in the method and the units in the apparatus disclosed in the embodiments of the present disclosure may be directly embodied as being implemented by a hardware processor, or implemented by a combination of hardware in the processor and other software modules. The software module may be located in a random memory, a flash memory, a read-only memory, a programmable read-only memory, an electrically erasable programmable memory, a register or the like storage medium commonly known in the art. The storage medium is located in the memory 42. The processor 41 reads the information stored in the memory 42 and performs the blocks of the above method in combination with the hardware thereof. For brevity of description, the details are not given herein any further.

In the embodiments of the present disclosure, the video playing apparatus differentiates an object to which an operation instruction is directed in the light-off state, such that the screen may not return to the non-full-screen play state when a user performs such an operation as pause, fast forward, backward or the like; and instead a watching effect in the light-off state is maintained. However, when an operation instruction is directed to the other regions apart from the video play window in which the video is being played, the screen returns to the initial non-full-screen play state, and a corresponding operation is performed, thereby improving user experience.

Persons of ordinary skill in the art should understand that the discussion of any of the above embodiments is exemplary, and is not intended to imply that the scope of the present disclosure (including the claims) is limited to these exemplary embodiments. The above embodiments, or the technical features in different embodiments may be combined, and various modifications may be made to different aspects of the present disclosure, which are not described in detail for brevity. Therefore, any omission, modification, equivalent replacement, or improvement made without departing from the spirit and principle of the present disclosure should fall within the protection scope of the present disclosure.

What is claimed is:

1. A method for video playing, the method comprising:
at a video playing terminal device,
starting timing from zero each time an operation instruction is received, during play of a video in a non-full-screen play state; and
displaying other regions apart from a video play window as dark regions, and entering a light-off state and continuing playing the video, if a timing duration reaches a first predetermined time interval.

2. The method according to claim 1, wherein displaying other screen regions apart from a video play window as dark regions, the method further comprises:
gradually deepening a gray scale of the other screen regions apart from the video play window until the other screen regions become dark regions within a second predetermined time interval;
and/or,
displaying a countdown identifier by using a third predetermined time interval as a time length in the other screen regions apart from the video play window.

3. The method according to claim 1, wherein prior to entering a light-off state and continuing playing the video, the method further comprises:
placing the video play window in the non-full-screen play state at a center of the screen.

4. The method according to claim 1, wherein prior to entering a light-off state and continuing playing the video, the method further comprises:
generating a light-off prompt tone.

5. The method according to claim 1, wherein after entering a light-off state and continuing playing the video, the method further comprises:
monitoring content in the other screen regions apart from the video play window in the light-off state;
locally lighting a region where updated content is located when it is monitored that content in any of the other screen regions is updated; and
entering the light-off state again if light-on time exceeds a fourth predetermined time interval.

6. The method according to claim 1, wherein after entering a light-off state and continuing playing the video, the method further comprises:
receiving an operation instruction in the light-off state;
judging whether the operation instruction is directed to a video which is being played;
maintaining the light-off state, and performing a corresponding operation for the video which is being played according to the operation instruction, if the operation instruction is directed to a video which is being played,; and
returning to the initial non-full screen play state, and performing a corresponding operation according to the operation instruction, if the operation instruction is not directed to a video which is being played.

7. An electronic device,comprising:
at least one processor; and
a memory communicably connected with the at least one processor for storing instructions executable by the at least one processor, wherein execution of the instructions by the at least one processor causes the at least one processor to:
start timing from zero each time an operation instruction is received, during play of a video in a non-full-screen play state,; and
display other regions apart from a video play window as dark regions, and enter a light-off state and continuing playing the video, if a timing duration reaches a first predetermined time interval.

8. The electronic device according to claim 7, wherein the execution of the instructions by the at least one processor causes the at least one processor to:gradually deepen a gray scale of the other screen regions apart from the video play window until the other screen regions become dark regions within a second predetermined time interval;
and/or,
display a countdown identifier by using a third predetermined time interval as a time length in the other screen regions apart from the video play window.

9. The electronic device according to claim 7, wherein the execution of the instructions by the at least one processor causes the at least one processor to place the video play window in the non-full-screen play state at a center of the screen.

10. The electronic device according to claim 7, wherein the execution of the instructions by the at least one processor causes the at least one processor to: generate a light-off prompt tone.

11. The apparatus according to claim 7, wherein the execution of the instructions by the at least one processor causes the at least one processor to:monitor content in the other screen regions apart from the video play window in the light-off state; and
locally highlight display of a region where updated content is located when it is monitored that content in any of the other screen regions is updated;
enter the light-off state again if light-on time exceeds a fourth predetermined time interval.

12. The electronic device according to claim 7, wherein the execution of the instructions by the at least one processor causes the at least one processor to receive an operation instruction in the light-off state;
judge whether the operation instruction is directed to a video which is being played;
return to the initial non-full screen play state if the operation instruction is not directed to a video which is being played;
maintain the light-off state; and perform an operation corresponding to the operation instruction, if the operation instruction is directed to a video which is being played.

13. A non-transitory computed readable storage medium, storage medium storing executable instructions wherein when executed by an electronic device, causes the electronic device to:
start timing from zero each time an operation instruction is received, during play of a video in a non-full-screen play state; and
display other regions apart from a video play window as dark regions, and enter a light-off state and continuing playing the video, if a timing duration reaches a first predetermined time interval.

14. The non-transitory computer-readable storage medium according to claim 13, wherein the execution of the instructions is executed by electronic device, causes the electronic device to:
gradually deepen a gray scale of the other screen regions apart from the video play window until the other screen regions become dark regions within a second predetermined time interval;
and/or,
display a countdown identifier by using a third predetermined time interval as a time length in the other screen regions apart from the video play window.

15. The non-transitory computer-readable storage medium according to claim 13, wherein the execution of the instructions is executed by electronic device, causes the electronic device to:
wherein the execution of the instructions by the at least one processor causes the at least one processor to place the video play window in the non-full-screen play state at a center of the screen.

16. The non-transitory computer-readable storage medium according to claim 13,wherein the execution of the instructions is executed by electronic device, causes the electronic device to:
wherein the execution of the instructions by the at least one processor causes the at least one processor to: generate a light-off prompt tone.

17. The non-transitory computer-readable storage medium according to claim 13,wherein the execution of the instructions is executed by electronic device, causes the electronic device to:
monitor content in the other screen regions apart from the video play window in the light-off state; and
locally highlight display of a region where updated content is located when it is monitored that content in any of the other screen regions is updated;
enter the light-off state again if light-on time exceeds a fourth predetermined time interval.

18. The non-transitory computer-readable storage medium according to claim 13,wherein the execution of the instructions is executed by electronic device, causes the electronic device to:
receive an operation instruction in the light-off state;
judge whether the operation instruction is directed to a video which is being played;
return to the initial non-full screen play state if the operation instruction is not directed to a video which is being played;
maintain the light-off state; and perform an operation corresponding to the operation instruction, if the operation instruction is directed to a video which is being played.
